(19) United States
(12) Patent Application Publication
(10) Pub. No.: US 2026/0274240 A1
(43) Pub. Date: Sep. 17, 2026

(54) CONTROL APPARATUS FOR VEHICLE

(71) Applicant: TOYOTA JIDOSHA KABUSHIKI KAISHA, Toyota-shi (JP)

(72) Inventors: Shota MIYAKE, Toyota-shi (JP); Masamitsu KOYASU, Nagoya-shi (JP); Naoki HIURA, Toyota-shi (JP); Tooru MATSUBARA, Toyota-shi (JP)

(73) Assignee: TOYOTA JIDOSHA KABUSHIKI KAISHA, Toyota-shi (JP)

(21) Appl. No.: 19/565,020

(22) Filed: Mar. 12, 2026

(30) Foreign Application Priority Data
Mar. 13, 2025 (JP) 2025-040717

(51) Int. Cl. B60W 10/02; B60W 10/04; B60W 20/40; B60W 50/00

(52) U.S. Cl. CPC B60W 10/02; B60W 10/04; B60W 20/40; B60W 50/0098; B60W 2510/0275; B60W 2510/0283; B60W 2520/10; B60W 2552/15; B60W 2710/025; B60W 2720/10

(57) ABSTRACT

A vehicle control apparatus including (a) a drive controller configured to control a power source, (b) a clutch controller configured to place the friction clutch in a slip state, when a vehicle starts running or runs within a small speed range; and (c) a state determiner configured to determine whether a running road is an uphill road or a flat road. The drive controller sets a slip-state target rotational speed that is a target value of a rotational speed of the power source during the slip state of the friction clutch, such that the slip-state target rotational speed is set to a first speed value when the running road is determined to be a flat road, and such that the slip-state target rotational speed is set to a second speed value that is smaller than the first speed value when the running road is determined to be an uphill road.

This application claims priority from Japanese Patent Application No. 2025-040717 filed on Mach 13, 2025, the disclosure of which is herein incorporated by reference in its entirety.

### FIELD OF THE INVENTION

The present invention relates to a control apparatus for a vehicle that includes a friction clutch in a power transmission path between a power source and a drive wheel.

### BACKGROUND OF THE INVENTION

There is known a control apparatus for a vehicle that includes a drive wheel, a power source and a friction clutch provided in a power transmission path between the power source and the drive wheel. For example, the vehicle control apparatus described in Patent Document 1 is such a control apparatus. Patent Document 1 discloses that, when the vehicle is to start running on a slope, a rotational speed of the power source is increased with the friction clutch being in a released state, and then the friction clutch is controlled toward an engaged state, and the torque of the power source is transmitted to the drive wheel via the friction clutch in a slip state, thereby improving a hill-climbing performance.

### PRIOR ART DOCUMENT

### Patent Document

[Patent Document 1] JP 2022-154284 A

### SUMMARY OF THE INVENTION

When the vehicle runs on an uphill road at a small running speed, an input torque to the friction clutch is made large and a difference between input and output rotational speeds of the friction clutch is made large. Further, when the vehicle runs on the uphill road, an increase of a running speed of the vehicle is slow, so that the large difference between the input and output rotational speeds of the friction clutch is likely to continue for a large length of time. Therefore, an amount of heat generated in the friction clutch, which is in a slip state, could be increased, whereby starting and running performances of the vehicle could be reduced in order to protect the friction clutch.

The present invention was made against the background of the above circumstances, and its purpose is to provide a control apparatus for a vehicle, which is capable of suppressing an amount of heat generation in a friction clutch when the vehicle starts running or runs on an uphill road.

According to the present invention, there is provided a control apparatus for a vehicle which is to run on a running road and which includes (i) a drive wheel, (ii) a power source and (iii) a friction clutch provided in a power transmission path between the power source and the drive wheel. The control apparatus includes: (a) a drive controller configured to control the power source in accordance with a drive demand amount for the vehicle; (b) a clutch controller configured to place the friction clutch in a slip state, when the vehicle is to be caused to start running or is to be caused to run at a running speed within a predetermined small speed range; and (c) a state determiner configured to determine that the running road is an uphill road when a road gradient is not smaller than a predetermined gradient value, and to determine that the running road is a flat road when the road gradient is smaller than the predetermined gradient value. The drive controller is configured to set a slip-state target rotational speed that is a target value of a rotational speed of the power source during the slip state of the friction clutch, such that the slip-state target rotational speed is set to a first speed value when it is determined that the running road is the flat road, and such that the slip-state target rotational speed is set to a second speed value that is smaller than the first speed value when it is determined that the running road is the uphill road.

In the control apparatus according to the present invention, when the running road is determined to be an uphill road, the slip-state target rotational speed, which is the target value for the rotational speed of the power source when the friction clutch is in a slip state, is set to a smaller rotational speed than when the running road is determined to be a flat road. As a result, when the running road is an uphill road and the friction clutch is in the slip state, the difference between the input and output rotational speeds of the friction clutch is kept small. Therefore, an amount of heat generated in the friction clutch can be suppressed when the vehicle starts running or runs on an uphill road.

### BRIEF DESCRIPTION OF THE DRAWINGS

FIG. 1 is a view schematically showing a construction of a vehicle to which the present invention is applied, and also control functions and main parts of a control system for various controls in the vehicle.

FIGS. 2A and 2B are views explaining an example of a construction of a starting clutch, wherein FIG. 2A shows the construction of the starting clutch with an internal tooth disc, and FIG. 2B shows the starting clutch with an external tooth disc.

FIG. 3 is a view explaining an example of setting of a slip-state target rotational speed when the vehicle starts running.

FIG. 4 is a flowchart showing a main control operation of an electronic control apparatus, namely, a control routine executed by the electronic control apparatus for suppressing an amount of heat generation in the starting clutch when the vehicle starts running or runs on an uphill road.

FIG. 5 is a time chart when the control routine shown in the flowchart of FIG. 4 is executed in a case in which the vehicle enters an uphill road during running of the vehicle.

FIG. 6 is a time chart when the control routine shown in the flowchart of FIG. 4 is executed in a case in which a running speed is increased after the vehicle enters an uphill road during running of the vehicle.

### DETAILED DESCRIPTION OF PREFERRED EMBODIMENT

Hereinafter, a preferred embodiment of the present invention will be described in detail with reference to the drawings.

### Embodiment

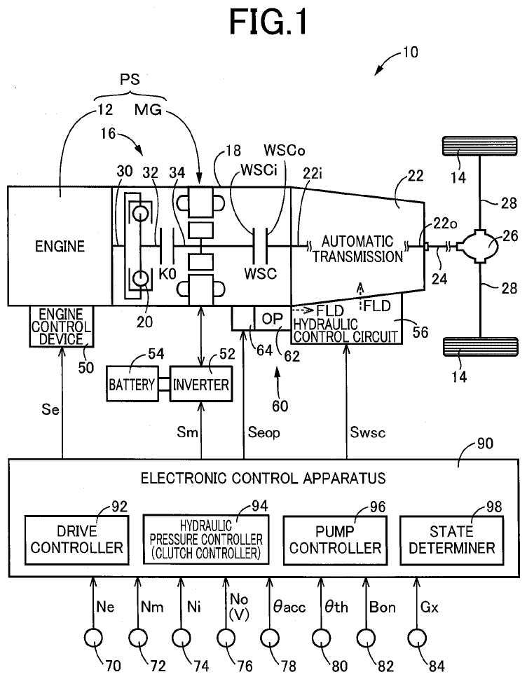

FIG. 1 is a view schematically showing a construction of a vehicle 10 to which the present invention is applied, and also control functions and main parts of a control system for various controls in the vehicle 10. As shown in FIG. 1, the vehicle 10 is a hybrid electric vehicle equipped with an engine 12 and an electric motor MG. The engine 12 and the electric motor MG each constitute a power source PS in the present invention. The vehicle 10 also includes drive wheels 14 and a power transmission device 16 that is provided in a power transmission path between the engine 12 and the drive wheels 14.

The engine 12 is, for example, a known internal combustion engine. An engine torque Te of the engine 12 is controlled by an engine control device 50 provided in the vehicle 10, which is controlled by an electronic control apparatus 90.

The electric motor MG is a known rotating electric machine, a so-called motor generator. The electric motor MG is connected to a battery 54 provided in the vehicle 10 via an inverter 52 provided in the vehicle 10. The inverter 52 is controlled by the electronic control apparatus 90, thereby controlling an electric motor torque Tm of the electric motor MG.

The power transmission device 16 is provided with a damper 20, a connection/disconnection clutch K0, a starting clutch WSC, an automatic transmission 22 and the like, within a casing 18, which is a non-rotary member attached to a body of the vehicle 10. The damper 20 is provided in a power transmission path between the engine 12 and the connection/disconnection clutch K0. The connection/disconnection clutch K0 is provided in a power transmission path between the engine 12 and the electric motor MG. The connection/disconnection clutch K0 is, for example, a hydraulic friction engagement device, and a controlled state of the connection/disconnection clutch K0 is to be switched among an engaged state, a slip state and a released state, for example. The starting clutch WSC is provided between the electric motor MG and the automatic transmission 22 in a power transmission path between the engine 12 and the drive wheels 14. The automatic transmission 22 is provided between the starting clutch WSC and the drive wheels 14 in a power transmission path between the power source PS and the drive wheels 14. The automatic transmission 22 is, for example, a known planetary gear type automatic transmission.

The power transmission device 16 includes a propeller shaft 24 connected to a transmission output shaft 22o, a differential gear device 26 connected to the propeller shaft 24 and a pair of drive shafts 28 connected to the differential gear device 26. The transmission output shaft 22o is the output rotary member of the automatic transmission 22. The power transmission device 16 includes, within the casing 18, an engine connection shaft 30 connecting the engine 12 and the damper 20, a damper connection shaft 32 connecting the damper 20 and the connection/disconnection clutch K0, and an electric-motor connection shaft 34 connecting the connection/disconnection clutch K0 and the starting clutch WSC. The electric motor MG is connected to the electric-motor connection shaft 34 in a power transmittable manner within the casing 18. The power transmission device 16 is located in the power transmission path between the power source PS and the drive wheels 14, excluding the damper 20 and the connection/disconnection clutch K0.

The starting clutch WSC includes an input plate WSCi connected to the electric-motor connection shaft 34 and an output plate WSCo connected to a transmission input shaft 22i. The starting clutch WSC is, for example, a known hydraulic friction engagement device. The starting clutch WSC is a friction clutch in the present invention, and is provided in the power transmission path between the power source PS and the drive wheels 14. The transmission input shaft 22i is an input rotary member of the automatic transmission 22. The input plate WSCi is an input member of the starting clutch WSC. The output plate WSCo is an output member of the starting clutch WSC. A controlled state of the starting clutch WSC is to be switched among an engaged state, a slip state and a released state, with a starting clutch torque Twsc being changed by a starting-clutch hydraulic pressure PRwsc. The starting-clutch hydraulic pressure PRwsc is controlled by a hydraulic control circuit 56 provided in the vehicle 10. The starting clutch torque Twsc is a torque capacity of the starting clutch WSC.

The power of the power source PS is transmitted to the drive wheels 14 via the starting clutch WSC, for example. The power of the engine 12 is transmitted to the drive wheels 14 when the connection/disconnection clutch K0 and the starting clutch WSC are both in the engaged states or slip states. The power of the electric motor MG is transmitted to the drive wheels 14 when the starting clutch WSC is in the engaged state or slip state, regardless of the controlled state of the connection/disconnection clutch K0.

The vehicle 10 is equipped with an oil pump 60. The oil pump 60 includes a pump body 62 and a pump motor 64. The oil pump 60 is an electric oil pump that discharges an oil FLD used in the power transmission device 16 when the pump motor 64 rotates and drives the pump body 62. The oil FLD discharged by the oil pump 60 is supplied to the hydraulic control circuit 56. The hydraulic control circuit 56 supplies the starting-clutch hydraulic pressure PRwsc which is adjusted based on the oil FLD discharged by the oil pump 60. The oil FLD is a working fluid for operating the connection/disconnection clutch K0, the starting clutch WSC and the automatic transmission 22. The oil FLD is also used for lubricating and cooling various parts of the power transmission device 16. For example, the oil FLD is a fluid for lubricating the starting clutch WSC. The oil pump 60 is an electric fluid pump for supplying the oil FLD.

The vehicle 10 further includes the electronic control apparatus 90 as a controller. The electronic control apparatus 90 includes a so-called microcomputer equipped with, for example, a CPU, a RAM, a ROM and an input/output interface. The CPU executes various controls in the vehicle 10 by, for example, utilizing a temporary storage function of the RAM and performing signal processing in accordance with programs pre-stored in the ROM. The electronic control apparatus 90 is the control apparatus of the present invention.

The electronic control apparatus 90 receives various signals based on detection signals from various sensors provided in the vehicle 10. The various sensors include, for example, an engine rotational-speed sensor 70, an electric motor rotational-speed sensor 72, an input rotational-speed sensor 74, an output rotational-speed sensor 76, an acceleration opening-degree sensor 78, a throttle-valve opening-degree sensor 80, a brake switch 82 and an acceleration sensor 84. The various signals include, for example, an engine rotational speed Ne, an electric-motor rotational speed Nm, a transmission-input rotational speed Ni, a transmission-output rotational speed No, an acceleration opening degree θacc, a throttle valve opening degree θth, a brake-ON signal Bon and a longitudinal acceleration Gx.

The engine rotational speed Ne is a rotational speed of the engine 12. The electric-motor rotational speed Nm is a rotational speed of the electric motor MG. The electric-motor rotational speed Nm is also a rotational speed of the input plate WSCi, i.e., an input rotational speed of the starting clutch WSC. When the connection/disconnection clutch K0 is in the engaged state, the electric motor rotational speed Nm and the engine rotational speed Ne are considered to be the same. The transmission-input rotational speed Ni is a rotational speed of the transmission input shaft 22i. The transmission-input rotational speed Ni is also a rotational speed of the output plate WSCo, i.e., an output rotational speed of the starting clutch WSC. The transmission-output rotational speed No is a rotational speed of the transmission output shaft 22o. The transmission-output rotational speed No is also a rotational speed corresponding to a running speed V of the vehicle 10. The acceleration opening degree θacc is a signal that indicates an amount of accelerator operation by a driver of the vehicle 10, which indicates a magnitude of acceleration/deceleration operation made by the driver. The throttle-valve opening degree θth is a signal that indicates an opening degree of the electronic throttle valve. The brake ON signal Bon is a signal that indicates a state in which a brake pedal to activate a wheel brake is being operated by the driver. The longitudinal acceleration Gx is an acceleration of vehicle 10 in forward/reverse direction.

The electronic control apparatus 90 calculates a clutch rotational-speed difference ΔNwsc (=Nm−Ni) by using the electric-motor rotational speed Nm and the transmission-input rotational speed Ni. The clutch rotational-speed difference ΔNwsc is a difference between the input and output rotational speeds of the starting clutch WSC. The difference between the input and output rotational speeds of the starting clutch WSC is a difference between the input rotational speed of the starting clutch WSC and the output rotational speed of the starting clutch WSC.

The electronic control apparatus 90 outputs various command signals to various devices provided in the vehicle 10. The various devices include the engine control device 50, the inverter 52, the hydraulic control circuit 56 and the oil pump 60. The various command signals include an engine control command signal Se, an electric-motor control command signal Sm, a starting-clutch hydraulic control command signal Swsc and an oil-pump control command signal Seop.

The electronic control apparatus 90 includes a drive controller 92, a hydraulic controller 94 and a pump controller 96, so as to realize various controls in the vehicle 10.

The drive controller 92 calculates a drive demand amount DEM from the driver for the vehicle 10, for example, by applying the acceleration opening degree θacc and the running speed V to a drive demand amount map. The drive demand amount map is a stored relationship for calculating the drive demand amount DEM, and is determined in advance, for example, experimentally or by design. The drive demand amount DEM is, for example, a required drive torque Trdem [Nm] that is a required value of the drive torque Tr at the drive wheels 14, or a required drive power Frdem [N] that is a required value of the drive power Fr at the drive wheels 14. The drive controller 92 controls the power source PS based on the drive demand amount DEM. The drive controller 92 outputs the control command signals (Se, Sm) that control the power source PS such that a power source torque Tps is obtained to realize the drive demand amount DEM. The power source torque Tps is a torque of the power source PS.

The hydraulic controller 94 determines whether a gear shift is required in the automatic transmission 22, for example, by using a predetermined gear shift map, and outputs a gear-shift control command signal to the hydraulic control circuit 56 to execute a gear shift control for the automatic transmission 22 such that the determined gear is formed as necessary. In controlling the gear shift of the automatic transmission 22, the hydraulic controller 94 switches each engagement device involved in forming the gear between a released state and an engaged state, for example.

When the vehicle 10 is being stopped due to braking, the hydraulic controller 94 outputs the starting-clutch hydraulic control command signal Swsc by which the starting clutch WSC is kept in the released state, for example. When the vehicle 10 starts running, the hydraulic controller 94 outputs a starting-clutch hydraulic control command signal Swsc that switches the starting clutch WSC from a released state to an engaged state while slipping. When the vehicle 10 is running, the hydraulic controller 94 outputs the starting-clutch hydraulic control command signal Swsc by which the starting clutch WSC is kept in the engaged state. However, when the vehicle 10 is running at a running speed within a predetermined small speed range, for example, the hydraulic controller 94 outputs the starting-clutch hydraulic control command signal Swsc by which the starting clutch WSC is placed in the slip state. The predetermined small speed range is a small running range in which it is not desirable to place the starting clutch WSC into the engaged state, for example, to prevent engine stalling or to suppress vibrations. The hydraulic controller 94 is a clutch controller in the present invention, which controls the starting clutch WSC to the slip state when the vehicle 10 is caused to start running or when the vehicle 10 is caused to run at the running speed within the predetermined small speed range. It is noted that, when the vehicle 10 is stopped due to braking, the hydraulic controller 94 may, for example, control the starting clutch WSC to the slip state to an extent that starting clutch torque Twsc is hardly generated.

The drive controller 92 sets the slip-state target rotational speed Npstgt when the starting clutch WSC is controlled to be placed in the slip state. The slip-state target rotational speed Npstgt is a target value of a power-source rotational speed Nps when the starting clutch WSC is in the slip state. The power-source rotational speed Nps is a rotational speed of the power source PS. When the connection/disconnection clutch K0 is in the engaged state, the power-source rotational speed Nps corresponds to each of the engine rotational speed Ne, the electric motor rotational speed Nm and the rotational speed of the input plate WSCi. When the connection/disconnection clutch K0 is in the released state, the power-source rotational speed Nps corresponds to each of the electric motor rotational speed Nm and the rotational speed of the input plate WSCi. For example, the larger the drive demand amount DEM, the larger the slip-state target rotational speed Npstgt is set by the drive controller 92. For example, the larger the acceleration opening degree θacc, the larger the slip-state target rotational speed Npstgt is set by the drive controller 92. For example, the larger the running speed V, the larger the slip-state target rotational speed Npstgt is set by the drive controller 92. When the starting clutch WSC is controlled to be placed in the slip state, the drive controller 92 controls the power source PS to realize the set slip-state target rotational speed Npstgt.

The pump controller 96 sets a target pump rotational speed Neoptgt according to the controlled states of the connection/disconnection clutch K0, the starting clutch WSC and the engagement devices in the automatic transmission 22. The pump controller 96 outputs the oil pump control command signal Seop by which the oil pump 60 is driven at the target pump rotational speed Neoptgt. The target pump rotational speed Neoptgt is, for example, a predetermined target value of the pump rotational speed Neop for supplying the oil FLD at a flow rate required for the operations of the connection/disconnection clutch K0, the starting clutch WSC and the engagement devices in the automatic transmission 22. The target pump rotational speed Neoptgt is also, for example, a predetermined target value of the pump rotational speed Neop for ensuring the flow rate of the oil FLD required for lubricating and cooling parts of the power transmission device 16. The pump rotational speed Neop is a rotational speed of the oil pump 60.

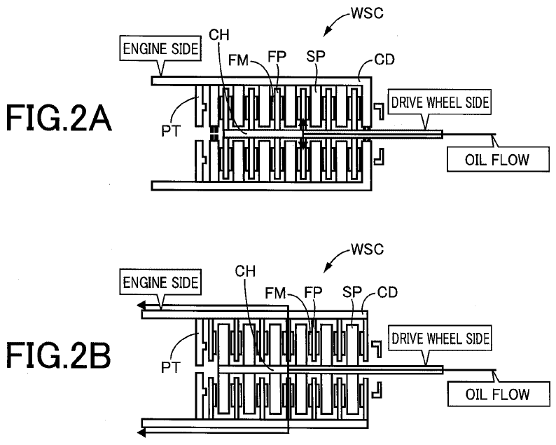

FIGS. 2A and 2B are views explaining an example of a construction of the starting clutch WSC. FIG. 2A shows the construction of the starting clutch WSC with an internal tooth disc, namely, with friction plates FP being located on an inner peripheral side. FIG. 2B shows the construction of the starting clutch WSC with an external tooth disc, namely, with the friction plates FP being located on an outer peripheral side.

As shown in FIGS. 2A and 2B, the starting clutch WSC includes a clutch drum CD, a clutch hub CH, separate plates SP, friction plates FP and a piston PT. The clutch drum CD is connected to the electric-motor connection shaft 34. The clutch hub CH is connected to the transmission input shaft 22i. The separate plates SP and the friction plates FP are interposed between each other, and constitute a plurality of generally annular-shaped plate members. The starting clutch WSC is a wet multi-plate friction clutch. When the starting-clutch hydraulic pressure PRwsc is supplied to the starting clutch WSC, the piston PT is pressed against the separate plates SP and friction plates FP, whereby the starting clutch WSC is controlled toward the engaged state.

In FIG. 2A, the separate plates SP serve as the input plate WSCi, and their outer peripheral edges are splined to an inner circumferential surface of the clutch drum CD so as to be non-rotatable relative to the clutch drum CD. The friction plates FP serve as the output plate WSCo, and their inner peripheral edges are splined to an outer circumferential surface of the clutch hub CH so as to be non-rotatable relative to the clutch hub CH. In FIG. 2B, the friction plates FP serve as the input plate WSCi, and their outer peripheral edges are splined to the inner circumferential surface of the clutch drum CD so as to be non-rotatable relative to the clutch drum CD. The separate plates SP serve as the output plate WSCo, and their inner peripheral edges are splined to the outer circumferential surface of the clutch hub CH so as to be non-rotatable relative to the clutch hub CH.

In the starting clutch WSC, the oil FLD is supplied to the separate plates SP and the friction plates FP for lubrication. The lubricating oil FLD is circulated through the clutch hub CH and is supplied from the axis toward the outer periphery by centrifugal force. The starting clutch WSC generates heat due to its slip state. If the starting clutch WSC generates the heat too much, the durability could be reduced, so that it is cooled by the lubricating oil FLD. The lubricating oil FLD is used to cool the starting clutch WSC.

When the vehicle 10 runs within a small running speed range with the starting clutch WSC being in a slip state, the rotational speed of the output plate WSCO is reduced whereby the clutch rotational-speed difference ΔNwsc is likely to be increased. When the vehicle 10 runs on an uphill road, a clutch input torque Tinwsc is likely to be increased. Also, when the vehicle 10 runs on the uphill road, an increase of the running speed V is slow whereby the clutch rotational-speed difference ΔNwsc is likely to remain large for a large length of time, so that the heat generation amount in the starting clutch WSC, which is in a slip state, is likely to be increased. The clutch input torque Tinwsc is a torque inputted to the starting clutch WSC, in other words, the input torque to the starting clutch WSC.

During running of the vehicle 10 within a small running speed range, the rotational speed of the clutch hub CH is made small, so that the flow rate of the lubricating oil FLD supplied to the separate plates SP and the friction plates FP is made small and there is a risk of reduction of cooling performance. Therefore, when the vehicle 10 is driven with a large load at a small running speed, for example, on an uphill road, the amount of heat generated in the starting clutch WSC is increased, so that placing the starting clutch WSC into the slip state is limited to protect the starting clutch WSC, thereby resulting in reduction of the starting and running performances.

Further, in the case (see FIG. 2B) in which the separate plates SP serve as the output plate WSCo in the starting clutch WSC, rotations of the separate plates SP having large heat capacity are stopped during stop of the vehicle 10, whereby the cooling performance is further reduced. Therefore, in the case in which the starting clutch WSC is constructed as shown in FIG. 2B, the cooling performance is inferior to the case in which the starting clutch WSC is constructed as shown in FIG. 2A, and there is a concern that the running performance may be further reduced. The heat capacity of the separate plates SP is a measure of how much heat is absorbed from friction members FM of the friction plates FP. When rotations of the separate plates SP are stopped, only portion of the separate plates SP are immersed in an oil pool, which means that an entirety of each of the separate plates SP is not immersed in the oil pool, so that the cooling performance is reduced.

Therefore, when there is a high possibility that the vehicle 10 would be traveling with a large load at a small running speed, the drive controller 92 sets the slip-state target rotational speed Npstgt to a smaller value than when there is a low possibility that the vehicle would be traveling with a large load at a small running speed. This reduces the clutch rotational-speed difference ΔNwsc, thereby suppressing the amount of heat generation in the starting clutch WSC.

The electronic control apparatus 90 further includes a state determiner 98 for appropriately suppressing the amount of heat generation in the starting clutch WSC.

The state determiner 98 calculates a road gradient Φ based on, for example, a longitudinal acceleration Gx of the vehicle 10. The road gradient Φ is a gradient of a road on which the vehicle 10 runs. The state determiner 98 determines whether the road gradient Φ is equal to or larger than a predetermined gradient value Φf. When the road gradient Φ is equal to or larger than the predetermined gradient value Φf, the state determiner 98 determines that the running road is an uphill road. When the road gradient Φ is smaller than the predetermined gradient value Φf, the state determiner 98 determines that the running road is a flat road. The predetermined gradient value Φf is a predetermined threshold value for determining whether the vehicle 10 is located on an uphill road that is predicted to be highly likely to be driven with a large load at a small running speed. When the running road is determined to be an uphill road, this is the same as when it is predicted that the vehicle 10 is likely to be driven with a large load and at a small running speed. When the running road is determined to be a flat road, this is the same as when it is predicted that the vehicle 10 is unlikely to be driven with a large load at a small running speed.

When the state determiner 98 determines that the running road is an uphill road, the drive controller 92 sets the slip-state target rotational speed Npstgt to a rotational speed that is smaller than when the state determiner 98 determines that the running road is a flat road.

When the state determiner 98 determines that the running road is a flat road, the drive controller 92 sets the slip-state target rotational speed Npstgt to a normal-state rotational speed Npsnml. The normal-state rotational speed Npsnml is a predetermined flat-road rotational speed that is set in advance as the slip-state target rotational speed Npstgt when the running road is determined to be a flat road. The normal-state rotational speed Npsnml is the rotational speed when the running road is determined to be a flat road. The drive controller 92 executes a normal rotational speed control for controlling the power-source rotational speed Nps to realize the set normal-state rotational speed Npsnml. The normal-state rotational speed Npsnml corresponds to “first speed value” in the present invention.

When the state determiner 98 determines that the running road is an uphill road, the drive controller 92 sets the slip-state target rotational speed Npstgt to an uphill-state rotational speed Npscg. The uphill-state rotational speed Npscg is a predetermined uphill-road rotational speed that is smaller than the normal-state rotational speed Npsnml and is predetermined as the slip-state target rotational speed Npstgt for suppressing the heat generation amount in the starting clutch WSC when the road is determined to be an uphill road. The uphill-state rotational speed Npscg is the rotational speed when the running road is determined to be an uphill road. When the road is determined to be an uphill road, the power-source rotational speed Nps is made smaller as compared to when the road is determined to be a flat road, thereby reducing the clutch rotational-speed difference ΔNwsc and suppressing the heat generation amount in the starting clutch WSC. The drive controller 92 sets the power-source rotational speed Npscg to realize the set uphill-state rotational speed Npscg. The drive controller 92 execute a rotational-speed suppression control by controlling the engine rotational speed Ne to the uphill-state rotational speed Npscg, for example, by using the electric motor MG. If it is not possible to use the electric motor MG, the drive controller 92 executes the rotational-speed suppression control by controlling the engine rotational speed Ne to the uphill-state rotational speed Npscg by a throttle control by the engine control device 50, for example. The uphill-state rotational speed Npscg corresponds to “second speed value” in the present invention.

Even when the running road is determined to be an uphill road, if the running speed V is at a certain level or more, the transmission-input rotational speed Ni is increased and the clutch rotational-speed difference ΔNwsc is reduced. In this case, it is assumed that the starting clutch WSC would be soon placed into the engaged state. As a result, the amount of heat generation in the starting clutch WSC is suppressed, so the power-source rotational speed Nps does not need to be reduced, and the slip-state target rotational speed Npstgt can be kept at normal-state rotational speed Npsnml.

The state determiner 98 determines whether the clutch rotational-speed difference ΔNwsc (=Nm−Ni) is equal to or larger than the predetermined difference value ΔNwscf. The transmission-input rotational speed Ni is a value determined based on the transmission-output rotational speed No corresponding to the running speed V and a gear position of the automatic transmission 22. For the same gear position, the smaller the running speed V, the larger the clutch rotational-speed difference ΔNwsc. Determining whether the clutch rotational-speed difference ΔNwsc is equal to or larger than the predetermined difference value ΔNwscf is equivalent to determining whether the running speed V is equal to or smaller than the predetermined speed value Vf. The predetermined difference value ΔNwscf and the predetermined speed value Vf are predetermined thresholds for determining whether the vehicle 10 is in a state in which, for example, the starting clutch WSC is expected to be placed into the engaged state early. It is noted that the predetermined speed value Vf is set to a value that varies depending on the position of the automatic transmission 22.

Even when the state determiner 98 determines that the running road is an uphill road, the drive controller 92 sets the slip-state target rotational speed Npstgt to the normal-state rotational speed Npsnml if the state determiner 98 determines that the running speed V is larger than the predetermined speed value Vf.

Even when the running road is determined to be an uphill road, if the clutch input torque Tinwsc is small, the heat generation amount in the starting clutch WSC is small. In this case, the power-source rotational speed Nps does not need to be reduced, and the slip-state target rotational speed Npstgt can be kept at the normal-state rotational speed Npsnml.

The state determiner 98 determines whether the clutch input torque Tinwsc is equal to or larger than a predetermined torque value Tinwscf. The clutch input torque Tinwsc corresponds to the power source torque Tps required to realize the drive demand amount DEM, for example. The predetermined torque value Tinwscf is a predetermined threshold value used to determine whether the clutch input torque Tinwsc is small enough to suppress the heat generation amount in the starting clutch WSC, for example.

Even when the state determiner 98 determines that the running road is an uphill road, the drive controller 92 sets the slip-state target rotational speed Npstgt to the normal-state rotational speed Npsnml if it is determined that the clutch input torque Tinwsc is smaller than the predetermined torque value Tinwscf.

When the state determiner 98 determines that the running road is an uphill road, the drive controller 92 sets the slip-state target rotational speed Npstgt to the uphill-state rotational speed Npscg if it is determined that the running speed V is equal to or smaller than the predetermined speed value Vf and that the clutch input torque Tinwsc is equal to or larger than the predetermined torque value Tinwscf.

Even when the state determiner 98 determines that the running road is an uphill road, the drive controller 92 sets the slip-state target rotational speed Npstgt to the normal-state rotational speed Npsnml if it is determined that the running speed V is larger than the predetermined speed value Vf or if it is determined that the clutch input torque Tinwsc is smaller than the predetermined torque value Tinwscf.

If the power-source rotational speed Nps is changed in a stepwise manner when the setting of the slip-state target rotational speed Npstgt is switched from the normal-state rotational speed Npsnml to the uphill-state rotational speed Npscg, this may cause discomfort to the driver of the vehicle 10. This driver discomfort may be, for example, discomfort due to a sudden change of the power-source rotational speed Nps shown on a display, or discomfort due to a change of sound that accompanies a change of the rotational speed of the power source PS. When the vehicle 10 enters an uphill road while running on a flat road, the drive controller 92 transitions the slip-state target rotational speed Npstgt from the normal-state rotational speed Npsnml to the uphill-state rotational speed Npscg at a rate that is unlikely to cause discomfort to the driver.

Similarly, when the setting of slip-state target rotational speed Npstgt is switched from the uphill-state rotational speed Npscg to the normal-state rotational speed Npsnml, there is a risk of causing discomfort to the driver. When the running road is changed from an uphill road to a flat road, the drive controller 92 transitions the slip-state target rotational speed Npstgt from the uphill-state rotational speed Npscg to the normal-state rotational speed Npsnml at a rate that is unlikely to cause discomfort to the driver.

When the state determiner 98 determines whether the running road is an uphill road or a flat road, the drive controller 92 changes the slip-state target rotational speed Npstgt at a predetermined rate that is unlikely to cause discomfort to the driver.

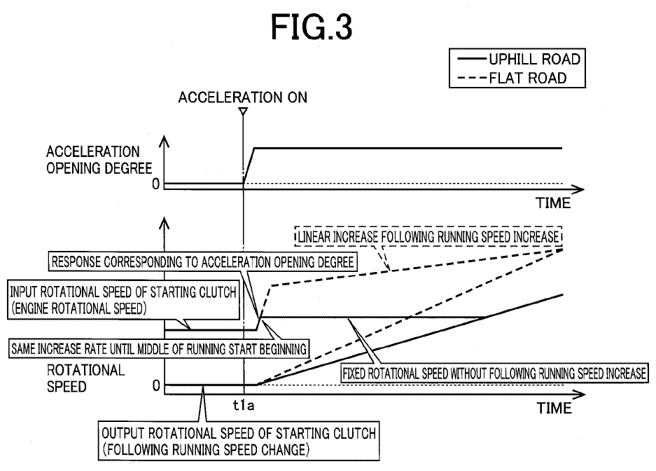

FIG. 3 is a view explaining an example of setting of the slip-state target rotational speed Npstgt when the vehicle 10 starts running. In FIG. 3, a time point t1a indicates a point of time at which the accelerator is turned ON while the vehicle 10 is being stopped. As the accelerator is turned ON, the starting clutch WSC is controlled to be placed into the slip state, and the power source torque Tps is increased, whereby the vehicle 10 is caused to start. As indicted by broken line, when the vehicle 10 starts running on a flat road, the slip-state target rotational speed Npstgt is increased at a rate dependent on the increase of the acceleration opening degree θacc at the beginning of the running start, and the rotational speed of the input plate WSCi is increased. Thereafter, the slip-state target rotational speed Npstgt is increased at a linear rate dependent on the increase of the running speed V, and the rotational speed of the input plate WSCi is increased. When the vehicle 10 starts running with the state determiner 98 determining that the running road is a flat road, the drive controller 92 sets the slip-state target rotational speed Npstgt at the beginning of the running start to a rotational speed that is increased at a predetermined start-beginning-stage rate θst that is dependent on the increase of the drive demand amount DEM. When the vehicle 10 starts running with the state determiner 98 determining that the running road is a flat road, the drive controller 92 sets the slip-state target rotational speed Npstgt at the beginning of the running start to a rotational speed that is increased at a flat-road-state rate θfl that is dependent on the increase of the running speed V. The flat-road-state rate θfl is a predetermined rate that is smaller than the start-beginning-stage rate θst. As shown by solid line, when the vehicle 10 starts running on an uphill road, the slip-state target rotational speed Npstgt is increased at a rate that is dependent on the increase of the acceleration opening degree θacc at the beginning of the running start, just as it is until middle of the beginning of the running start on a flat road, and the rotational speed of the input plate WSCi is increased. Thereafter, the slip-state target rotational speed Npstgt is fixed to a speed value at end of the beginning of the running start, and the rotational speed of the input plate WSCi is fixed to a rotational speed that does not follow the increase of the running speed V. As a result, even if the increase in running speed V is slowed when the vehicle 10 starts running on an uphill road, the clutch rotational-speed difference ΔNwsc is reduced, so that the heat generation amount in the starting clutch WSC is suppressed. It is noted that if the slip-state target rotational speed Npstgt after the end of the beginning of the running start is set to a value that is increased at a smaller rate than on a flat road, the clutch rotational-speed difference ΔNwsc is reduced. The slip-state target rotational speed Npstgt after the end of the beginning of the running start may be set to a rotational speed that is increased at a smaller rate than the flat-road-state rate θfl. When the vehicle 10 starts running with the state determiner 98 determining that the running road is an uphill road, the drive controller 92 sets the slip-state target rotational speed Npstgt at the beginning of the running start to a rotational speed that is increased at a rate smaller than the start-beginning-stage rate θst. When the vehicle 10 starts running with the state determiner 98 determining that the running road is an uphill road, the drive controller 92 sets the slip-state target rotational speed Npstgt after the beginning of the running start to a rotational speed that that is fixed to a speed value at end of the beginning of the running start. Alternatively, when the vehicle 10 starts running with the state determiner 98 determining that the running road is an uphill road, the drive controller 92 sets the slip-state target rotational speed Npstgt after the beginning of the running start to a rotational speed that is increased at a predetermined uphill-road-state rate θcg. The uphill-road-state rate θcg is a predetermined uphill road rate that is smaller than the flat-road-state rate θfl.

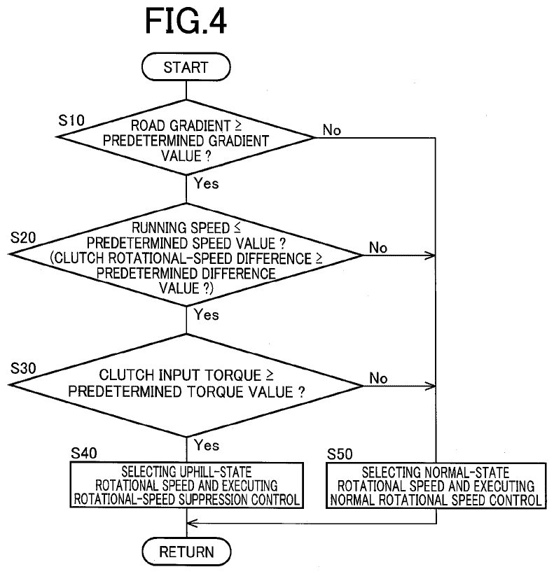

FIG. 4 is a flowchart showing a main control operation of the electronic control apparatus 90, namely, a control routine executed by the electronic control apparatus 90 for suppressing the amount of heat generation in the starting clutch WSC when the vehicle 10 starts running or runs on an uphill road. This control routine is executed in a repeated manner, for example.

As shown in FIG. 4, the control routine is initiated with step S10 corresponding to function of the state determiner 98, which is implemented to determine whether the road gradient Φ is equal to or larger than the predetermined gradient value Φf. When an affirmative determination is made at step S10, step S20 corresponding to function of the state determiner 98 is implemented to determine whether the running speed V is equal to or smaller than the predetermined speed value Vf. In other words, it is determined whether the clutch rotational-speed difference ΔNwsc is equal to or larger than the predetermined difference value ΔNwscf. When an affirmative determination is made at step S20, step S30 corresponding to function of the state determiner 98 is implemented to determine whether the clutch input torque Tinwsc is equal to or larger than the predetermined torque value Tinwscf. When an affirmative determination is made at step S30, step S40 corresponding to function of the drive controller 92 is implemented to set the slip-state target rotational speed Npstgt to the uphill-state rotational speed Npscg and to execute the rotational-speed suppression control. When a negative determination is made at step S10, S20 or S30, the control flow goes to step S50 corresponding to function of the drive controller 92, which is implemented to set the slip-state target rotational speed Npstgt to the normal-state rotational speed Npsnml and to execute the normal rotational speed control.

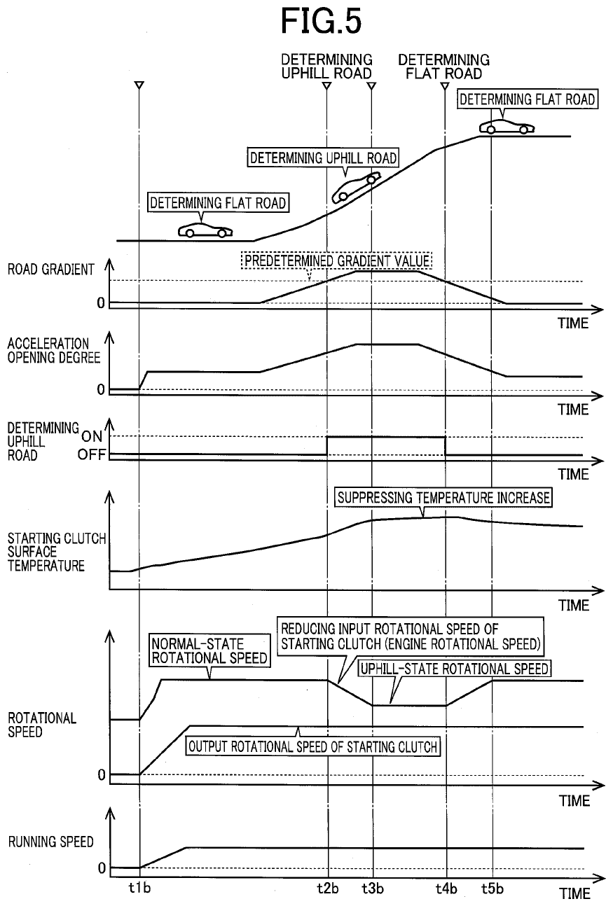

FIG. 5 is a time chart when the control routine shown in the flowchart of FIG. 4 is executed in a case in which the vehicle 10 enters an uphill road during running of the vehicle 10. In FIG. 5, a time point t1b indicates a point of time at which the accelerator pedal is started to be depressed on a flat road, thereby causing the vehicle 10 to start running. During running of the vehicle 10 on a flat road, when the road gradient Φ is determined to be equal to or larger than the predetermined gradient value Φf and the running road is determined to be an uphill road, the setting of slip-state target rotational speed Npstgt is changed from the normal-state rotational speed Npsnml to the uphill-state rotational speed Npscg (see time point t2b). At this time, the slip-state target rotational speed Npstgt is transitioned at a rate that is unlikely to cause discomfort to the driver (see time period t2b-t3b). When the road gradient Φ is determined to be equal to or larger than the predetermined gradient value Φf during running of the vehicle 10 on an uphill road, if the running road is determined to be a flat road because the road gradient Φ is determined to be smaller than the predetermined gradient value Φf, the setting of slip-state target rotational speed Npstgt is changed back to the normal-state rotational speed Npsnml (see time point t4b). At this time, the slip-state target rotational speed Npstgt is transitioned at a rate that is unlikely to cause discomfort to the driver (see time period t4b-t5b). When the vehicle 10 runs on an uphill road, the power-source rotational speed Nps is temporarily reduced so as to reduce the clutch rotational-speed difference ΔNwsc, whereby the increase of the surface temperature of the starting clutch WSC is suppressed. In this example shown in FIG. 5, the running of the vehicle 10 is continued with a small running speed being kept, so that the starting clutch WSC is controlled to the slip state.

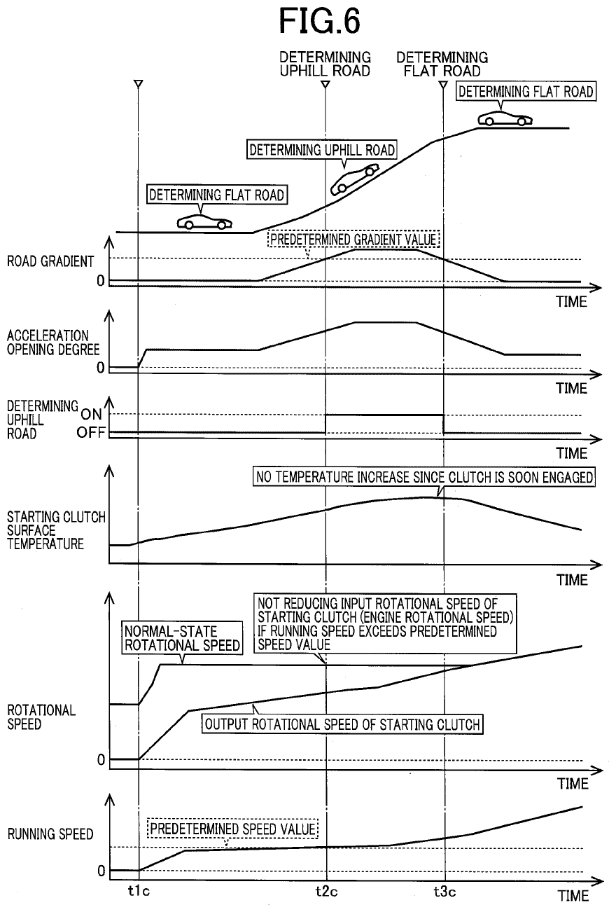

FIG. 6 is a time chart when the control routine shown in the flowchart of FIG. 4 is executed in a case in which the running speed V is increased after the vehicle 10 enters an uphill road during running of the vehicle 10. In FIG. 6, a time point t1c indicates a point of time at which the accelerator pedal is started to be depressed on a flat road, thereby causing the vehicle 10 to start running. During running of the vehicle 10 on a flat road, when the road gradient Φ is determined to be equal to or larger than the predetermined gradient value Φf, the running road is determined to be an uphill road (see time point t2c). During running of the vehicle 10 on an uphill road, when the road gradient Φ is determined to be smaller than the predetermined gradient value Φf, the running road is determined to be a flat road (see time point t3c). Even when the running road is determined to be an uphill road, if the running speed V is determined to be larger than the predetermined speed value Vf, the clutch rotational-speed difference ΔNwsc is small and it is assumed that the starting clutch WSC is about to be placed into the engaged state, so that there is no need to reduce the power-source rotational speed Nps. Therefore, the setting of the slip-state target rotational speed Npstgt is not changed from the normal-state rotational speed Npsnml (see time period t2c-t3c). For this determination, the clutch rotational-speed difference ΔNwsc may be used instead of using the running speed V. Even during running of the vehicle 10 on an uphill road, since the starting clutch WSC is about to be placed into the engaged state, the amount of heat generation in the starting clutch WSC is suppressed whereby the increase of the surface temperature is suppressed. In this example shown in FIG. 6, the starting clutch WSC is switched from the slip state to the engaged state as the running speed V is increased.

As described above, according to this embodiment, when the running road is determined to be an uphill road, the slip-state target rotational speed Npstgt is set to a smaller rotational speed than when the running road is determined to be a flat road. As a result, when the running road is an uphill road and the starting clutch WSC is in a slip state, the clutch rotational-speed difference ΔNwsc is kept small. Therefore, the amount of heat generation in the starting clutch WSC can be suppressed when the vehicle 10 starts running or runs on an uphill road.

According to this embodiment, even when the running road is determined to be an uphill road, if it is determined that the running speed V is larger than the predetermined speed value Vf, the slip-state target rotational speed Npstgt is set to the normal-state rotational speed Npsnml. As a result, when it is expected that the starting clutch WSC will be soon placed into the engaged state, the power-source rotational speed Nps is not reduced, thereby avoiding the driver from experiencing discomfort due to a change of the power-source rotational speed Nps.

According to this embodiment, even when the running road is determined to be an uphill road, if it is determined that the clutch input torque Tinwsc is smaller than the predetermined torque value Tinwscf, the slip-state target rotational speed Npstgt is set to the normal-state rotational speed Npsnml. As a result, when the heat generation amount in the starting clutch WSC is small, the power-source rotational speed Nps is not reduced, thereby avoiding the driver from experiencing discomfort due to a change of the power-source rotational speed Nps.

According to this embodiment, when the determination of the running road determination is switched between an uphill road and a flat road, the slip-state target rotational speed Npstgt is changed at a rate that is unlikely to cause discomfort to the driver. This suppresses the driver from experiencing discomfort due to a change of the power-source rotational speed Nps.

According to this embodiment, when the vehicle 10 starts running on an uphill road, the slip-state target rotational speed Npstgt at the beginning of the running start is set to a rotational speed that is increased at a rate smaller than the start-beginning-stage rate θst. When the vehicle 10 starts running on an uphill road, the slip-state target rotational speed Npstgt after the beginning of the running start is set to a rotational speed that is increased at the uphill-road-state rate θcg, or is set to a rotational speed that is fixed to at the speed value at the end of the beginning of the running start. This makes it possible to appropriately suppress the amount of heat generation in the starting clutch WSC when the vehicle 10 starts running on an uphill road.

Although the embodiment of the present invention has been described in detail above with reference to the drawings, the present invention can also be applied to other embodiments.

For example, in the above-described embodiment, the automatic transmission 22 may be, for example, a known DCT (Dual Clutch Transmission). Further, the starting clutch WSC may be a friction clutch that constitutes a part of the automatic transmission 22. Further, the power source PS may be, for example, the engine 12 alone, or the electric motor MG alone. When the power source PS is the engine 12 alone, a rotational-speed suppression control is executed, for example, by a throttle control using the engine control device 50. Further, where the starting clutch WSC is a friction clutch that transmits only the power of the electric motor MG, the automatic transmission 22 may not be provided. In short, the present invention can be applied to any vehicle that includes a power source PS, a starting clutch WSC and an oil pump 60.

In the above-described embodiment, the acceleration opening degree θacc and the clutch input torque Tinwsc are related with each other. However, the present invention is limited to this detail. For example, where the drive demand amount DEM is required by a known cruise control function, the clutch input torque Tinwsc may be increased or reduced during acceleration OFF.

In the above-described embodiment, at least one of steps S20 and S30 shown in FIG. 4 may not be provided. For example, where step S30 is not provided, when the running road is determined to be an uphill road and the running speed V is determined to be equal to or smaller than the predetermined speed value Vf, the slip-state target rotational speed Npstgt is set to the uphill-state rotational speed Npscg.

It should be noted that the above is merely one embodiment, and the present invention can be practiced in various forms with various modifications and improvements based on the knowledge of those skilled in the art.

### NOMENCLATURE OF ELEMENTS

10: vehicle
14: drive wheel
90: electronic control apparatus (control apparatus)
92: drive controller
94: hydraulic controller (clutch controller)
98: state determiner
PS: power source
WSC: starting clutch (friction clutch)
Npsnml: normal-state rotational speed (first speed value)
Npscg: uphill-state rotational speed (second speed value)

What is claimed is:

1. A control apparatus for a vehicle which is to run on a running road and which includes (i) a drive wheel, (ii) a power source and (iii) a friction clutch provided in a power transmission path between the power source and the drive wheel,
the control apparatus comprising:
a drive controller configured to control the power source in accordance with a drive demand amount for the vehicle;
a clutch controller configured to place the friction clutch in a slip state, when the vehicle is to be caused to start running or is to be caused to run at a running speed within a predetermined small speed range; and
a state determiner configured to determine that the running road is an uphill road when a road gradient is not smaller than a predetermined gradient value, and to determine that the running road is a flat road when the road gradient is smaller than the predetermined gradient value,
wherein the drive controller is configured to set a slip-state target rotational speed that is a target value of a rotational speed of the power source during the slip state of the friction clutch, such that the slip-state target rotational speed is set to a first speed value when it is determined that the running road is the flat road, and such that the slip-state target rotational speed is set to a second speed value that is smaller than the first speed value when it is determined that the running road is the uphill road.

2. The control apparatus according to claim 1,
wherein the state determiner is configured to determine whether a running speed of the vehicle is equal to or smaller than a predetermined speed value,
wherein the drive controller is configured to set the slip-state target rotational speed to the first speed value, in a case in which it is determined that the running speed of the vehicle is larger than the predetermined speed value, even when it is determined that the running road is the uphill road.

3. The control apparatus according to claim 1,
wherein the state determiner is configured to determine whether an input torque to the friction clutch is equal to or larger than a predetermined torque value, and
wherein the drive controller is configured to set the slip-state target rotational speed to the first speed value, in a case in which it is determined that the input torque to the friction clutch is smaller than the predetermined torque value, even when it is determined that the running road is the uphill road.

4. The control apparatus according to claim 1,
Wherein, in a case in which determination of the running road is switched between the uphill road and the flat road, the drive controller is configured to change the slip-state target rotational speed at a predetermined rate that is unlikely to cause discomfort to a driver of the vehicle.

5. The control apparatus according to claim 1,
wherein, in a case of running start of the vehicle when it is determined that the running road is the flat road, the drive controller is configured to set the slip-state target rotational speed, such that the slip-state target rotational speed at beginning of the running start is set to a rotational speed that is increased at a predetermined start-beginning-stage rate which is dependent on an increase of the drive demand amount, and such that the slip-state target rotational speed after the beginning of the running start is set to a rotational speed that is increased at a predetermined flat-road-state rate which is smaller than the start-beginning-stage rate and which is dependent on an increase of the running speed, and
wherein, in a case of the running start of the vehicle when it is determined that the running road is the uphill road, the drive controller is configured to set the slip-state target rotational speed, such that the slip-state target rotational speed at the beginning of the running start is set to a rotational speed that is increased at a rate smaller than the start-beginning-stage rate, and such that the slip-state target rotational speed after the beginning of the running start is set to a rotational speed that is increased at a predetermined uphill-road-state rate that is smaller than the flat-road-state rate or is set to a rotational speed that is fixed to a speed value at end of the beginning of the running start.
